(19) United States
(12) Patent Application Publication
(10) Pub. No.: US 2013/0340335 A1
(43) Pub. Date: Dec. 26, 2013

(54) Universal Luminous Flower Pot Base

(71) Applicant: MENQ-FONG SHIEH, Tainan (TW)

(72) Inventor: MENQ-FONG SHIEH, Tainan (TW)

(21) Appl. No.: 13/529,117

(22) Filed: Jun. 21, 2012

(51) Int. Cl. A01G 9/02

(52) U.S. Cl. 47/66.6

(57) ABSTRACT

A universal luminous flower pot base is disclosed, which comprises a base body, a luminous component and a power supply, wherein a flower pot tray and a luminous component mounting groove are arranged on the base body, the luminous component is mounted in the luminous component mounting groove of the base body, and the power supply is mounted on the base body and electrically connected with the luminous component. The flower pot base not only can obtain the positive effect of a luminous flower pot, but is also convenient for replacement and maintenance owing to strong universality, thus the flower pot base is applicable for wide use.

### TECHNICAL FIELD

The invention belongs to a universal flower pot component, and more particularly, relates to a universal luminous flower pot base.

### BACKGROUND

Since the ancient time, people in China have habituated themselves to planting flowers at home, and decorating household environment with various types of flowers and plants contributes to both cultivation of own mind and beautification of environment. To be matched with flowers and plants, flower pots in various shapes are used for flower plantation, such as common cone, cylinder, hexagonal prism, elongated strip, irregular shape, etc.; besides, in order to improve the aesthetic property of flower pot, the surface of flower pot is generally decorated with patterns plus various colors, thus better harmony between flower pot and plant can be obtained to attain perfection and unity.

Flower pot, though playing a role of holding flowers, is hardly clearly identified in an environment with low luminous intensity, and people who have the desire for flower appreciation could not enjoy seeing flowers at night.

In order to achieve clearer view of flowers planted in flower pot at night and improve the aesthetic property, people adopts a method of mounting a spotlight beside flower pot in the first place, however, the effect of this spotlight will be affected because there are a large number of flower pots that can be regulated in position under different situations, and the installation of the spotlight is high in cost. In order to solve this problem, a flower pot with luminous component has been invented, e.g. the techniques disclosed in the inventions of China: CN200520084525.4, CN201020631938.0 and CN200920151886.4, in these inventions, a power supply and a luminous component are mounted on the flower pot to achieve the technical effect of illumination at night. Nonetheless, a new technical problem emerges in the inventive disclosure of these patents above, namely, replacement of flower pot is inevitable in the case that this technique is used in the present pot culture, which is quite inconvenient and could lead to massive waste of old flower pots. Furthermore, a flower pot is difficult to replace after flowers are properly planted in, so this flower pot must be replaced when people wish to achieve new luminous and decorative effects, in this way, inconvenience is caused.

### SUMMARY OF THE INVENTION

The objective of the invention is to provide a universal luminous flower pot base applicable for most of the current flower pots, and this base not only can obtain the positive effect of a luminous flower pot, but is also convenient for replacement and maintenance.

The inventive objective of the invention may be implemented by the technical means as follows:

A universal luminous flower pot base comprises:

a base body, on which a flower pot tray and a luminous component mounting groove are arranged;

a luminous component, which is mounted in the luminous component mounting groove of the base body; and

a power supply, which is mounted on the base body and electrically connected with the luminous component.

The luminous component is an LED luminous component.

A hole for water drainage is arranged in the center of the flower pot tray.

The luminous component mounting groove is a ring-shaped groove surrounding the flower pot tray, and is positioned on the upper surface of the base body, namely the protruding part on the periphery of the flower pot tray.

The base body is a pot-shaped structure with an opening on the upper end, and the outer edge of the upper end of the base body protrudes outwards.

The pot-shaped base body is composed of a main pot and an auxiliary pot sleeved inside the main pot, wherein the bottom diameter of the auxiliary pot is smaller than that of the main pot.

The luminous component mounting groove is arranged on the lower part of the protruding outer edge on the upper end of the main pot of the base body.

The base body is an integrally hollow pot-shaped structure with hollow wall, and the base body is equipped with the flower pot tray having the outer diameter matched with the opening on the upper end of the base body.

The luminous component mounting groove is arranged on the outer edge of the base body.

The power supply is a solar energy supply component, which comprises a solar panel, a control circuit and a storage battery electrically connected with each other, wherein the storage battery and the control circuit are electrically connected with the luminous component respectively.

The invention has the following positive effects: 1. the luminous flower pot base is applicable for the size and shape of most of the flower pots, may be manufactured in multiple sizes as required, and can adapt to flower pots in different shapes by changing the shape and size of flower pot tray, thus convenient replacement and maintenance are achieved; 2. colorful lights in different colors can be mounted as required to obtain different styles of appearances, so people's demands are met; 3. when used in scenic spots, main streets, hotels, residential areas and other locations that are in need of flower decoration, the luminous flower pot base can obtain the effects of enhancing the beauty of scenery in the daytime, lightening flowers at night, indicating roads and beautifying environment; 4. when placed in the bedroom, living room, corridor and other places of a room, the luminous flower pot base, in addition to the effects of original flowers and plants like keeping clean air, sterilizing and removing dust, can also serve as a low-brightness lightening source that is normally on; and 5, if the design of solar battery is adopted in the luminous flower pot base, no energy consumption will be generated and energy will be saved, thus aesthetic property/practicability-integrated green lightening is realized in a real sense, and the luminous flower pot base is particularly applicable for wide use in household environments.

### BRIEF DESCRIPTION OF THE DRAWINGS

FIG. 1 is a structural schematic diagram of embodiment 1;

FIG. 2 is a perspective view of embodiment 1;

FIG. 3 is a perspective view (with flower pot) of embodiment 1;

FIG. 4 is a structural schematic diagram of embodiment 2;

FIG. 5 is a perspective view of embodiment 2;

FIG. 6 is a structural schematic diagram of embodiment 3;

FIG. 7 is a structural schematic diagram of embodiment 4;

FIG. 8 is a structural schematic diagram of embodiment 5;

### DETAILED DESCRIPTION OF THE EMBODIMENTS

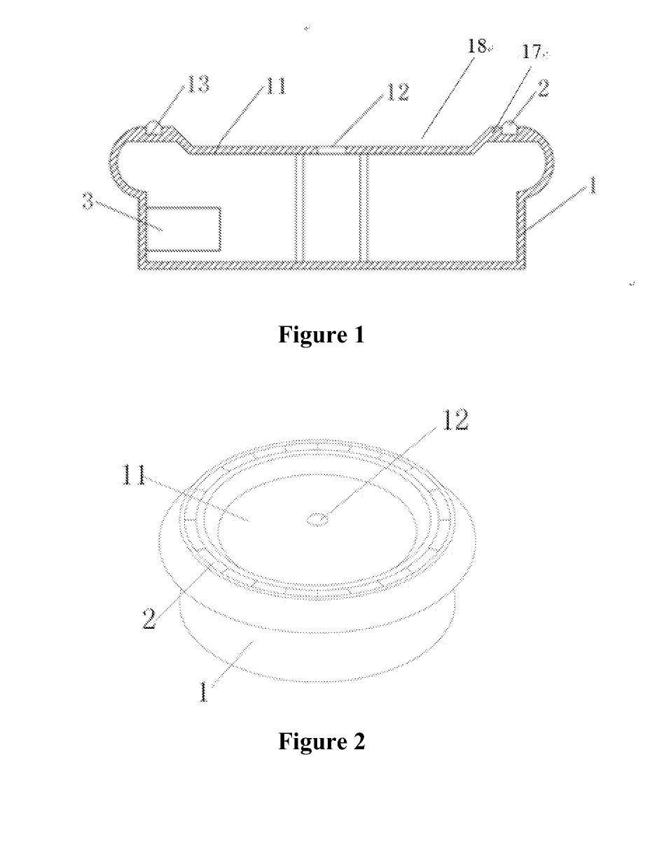

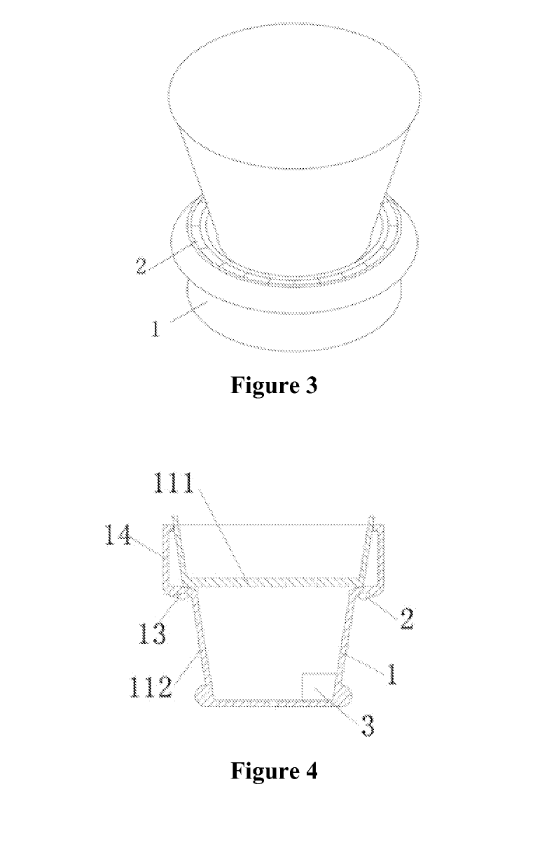

In the embodiment 1 shown as FIG. 1 to FIG. 3, the universal luminous flower pot base is composed of a base body 1, an LED luminous component 2 and a power supply 3, wherein the base body is a hollow round-table-type structure, the center part of the upper surface of the base body is recessed downwardly to form a flower pot tray 11, a hole for water drainage 12 is arranged in the center of the flower pot tray 11, a ring-shaped luminous component mounting groove 13 is arranged on the protruding part on the periphery of the flower pot tray 11, the LED luminous component is mounted in the luminous component mounting groove 13, and the power supply 3 is mounted in the hollow cavity of the base body and electrically connected with the luminous component 2

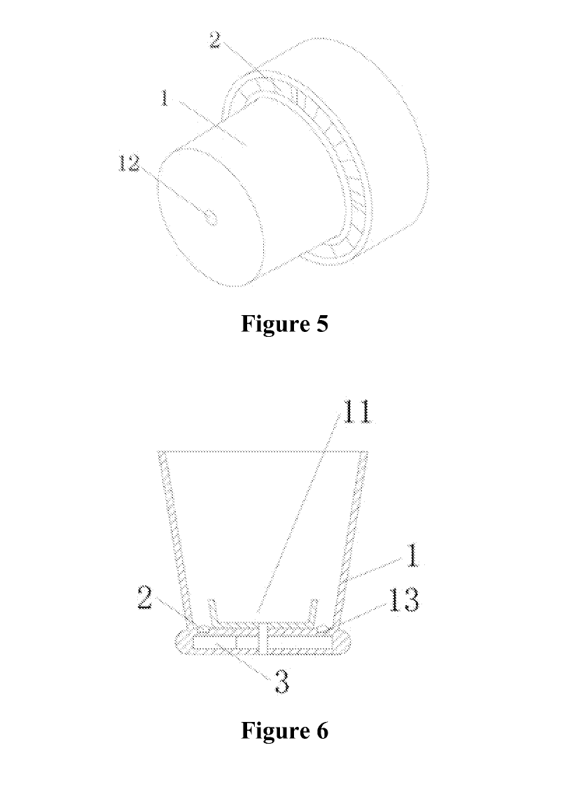

In the embodiment 2 shown as FIG. 4 and FIG. 5, the difference from the embodiment 1 is that the base body 1 in this embodiment is a pot-shaped structure with an opening on the upper end, the outer edge of the upper end 14 of the base body protrudes outwards, and the base body in this embodiment is composed of an auxiliary pot 111 and a main pot 112, wherein the auxiliary pot 111 has the bottom diameter smaller than the upper part diameter of the main pot 112 and can be sleeved inside the main pot 112, the size of the auxiliary pot 111 can be chosen according to the size of a flower pot that needs to be supported actually, and the ring-shaped luminous component mounting groove 13 is arranged on the lower part of the protruding outer edge 14 of the main pot 112.

In the embodiment 3 shown as FIG. 6, the difference from the two embodiments discussed above is that the base body 1 in this embodiment is an integrally hollow pot-shaped structure. The luminous component mounting groove 13 in this embodiment is arranged between the hollow outer wall of the base body 1 and the flower pot tray 11, and the luminous component 2 is mounted in the luminous component mounting groove 13.

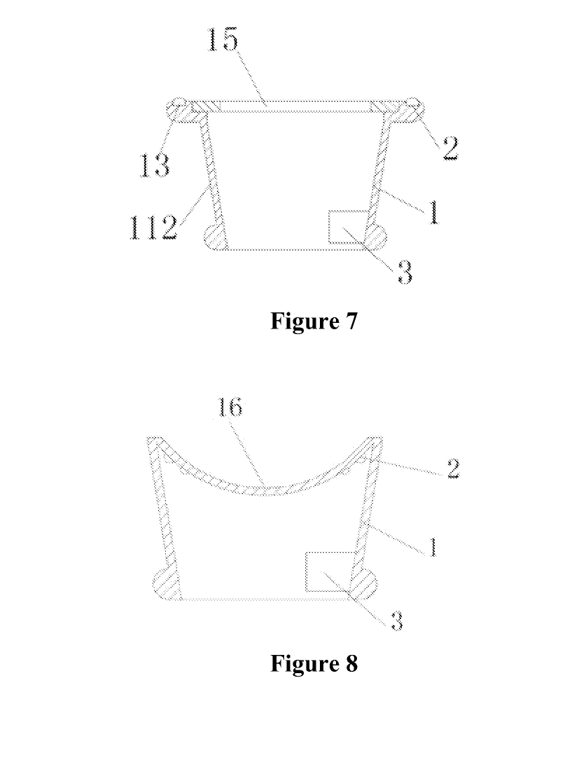

In the embodiment 4 shown as FIG. 7, the difference from the embodiments discussed above is that the base body 1 in this embodiment is an integrally hollow pot-shaped structure with hollow wall, and the base body is equipped with a ring-shaped flower pot tray 15. A common flower pot with a plant therein can be directly placed into the structurally-hollow base body 1 in this embodiment without transplantation. The ring-shaped flower pot tray 15 plays a role of adapting to internal flower pots with different diameters of the pot mouth. However, the luminous component 2 may also be mounted at the internal bottom side of the base body 1 to reflect hollow patterns, or mounted at the lower edge of the base body 1 to irradiate the wall of the flower pot.

In the embodiment 5 shown as FIG. 8, the difference from the embodiments discussed above is that the base body 1 in this embodiment is a hollow structure with the upper surface closed and the bottom opened, the upper surface of the base body 1 is recessed downwardly to form a pot support 16 for the placement of flower pot, the luminous component 2 is mounted on the lower surface of the pot support 16, namely the inside of the hollow base body 1, and the sidewall of the base body 1 is structurally hollow.

The power supply in the four embodiments discussed above is a rechargeable battery, but may also be a power supply for direct power supply or a solar energy supply component according to the demands, and if a solar energy supply component is adopted, the solar energy supply component comprises a solar panel, a control circuit and a storage battery that are electrically connected with each other, wherein the storage battery and the control circuit are electrically connected with the luminous component respectively.

1. A universal luminous flower pot base, comprising:
a base body comprising a flower pot tray on the top of the base body, and a protruding portion expanding upwardly from an edge of the flower pot tray, and wherein the protruding portion and the flower pot tray collectively form a recess to secure a flower pot, and the protruding portion defining a luminous component mounting groove;
a luminous component, which is mounted in the lunimous component mounting groove of the base body; and
a power supply, which is mounted on the base body and electrically connected with the luminous, component,

2. The universal luminous flower pot base according to claim 1, characterized in that: the luminous component is an LED, luminous component.

3. The universal luminous flower pot base according to claim 2, characterized in that: a hole for water drainage is arranged in the center of the flower pot tray.

4. The universal luminous flower pot base according to claim 3, characterized in that the luminous component mounting groove is a ring-shaped groove surrounding the flower pot tray, and is positioned on the upper surface of the protruding portion.

5. The universal luminous flower pot base according to claim 1, characterized in that: the base body is a pot-shaped structure with an opening on the upper end, and the outer edge of the upper end of the base body protrudes outwards.

6. The universal luminous flower pot base according to claim 1, characterized in that: the pot-shaped base body is composed of a main pot and an auxiliary pot sleeved inside the main pot, wherein the bottom diameter of the auxiliary pot is smaller than that of the main pot

7. The universal luminous flower pot base according to claim 6, characterized in that: the luminous component mounting groove is arranged on the lower part of the protruding outer edge on the upper end of the main pot of the base body.

8. The universal luminous flower pot base according to claim 1, characterized in that: the base body is an integrally hollow pot-shaped structure with hollow wall, and the base body is equipped with the flower pot tray having the outer diameter matched with the opening on the upper end of the base body.

9. The universal luminous flower pot base according to claim 8, characterized in that: the luminous component mounting groove is arranged on the outer edge of the base body.

10. The universal luminous flower pot base according to claim 1, characterized in that: the power supply is a solar energy supply component, which comprises a solar panel, a control circuit and a storage battery electrically connected with each other, wherein the storage battery and the control circuit are electrically connected with the luminous component respectively

11. The universal luminous flower pot base according to claim 2, characterized in that: the power supply is a solar energy supply component, which comprises a solar panel, a control circuit and a storage battery electrically connected with each other, wherein the storage battery and the control circuit are electrically connected with the luminous component respectively.

12. The universal luminous flower pot base according to claim 3, characterized in that: the power supply is a solar energy supply component, which comprises a solar panel, a control circuit and a storage battery electrically connected with each other, wherein the storage battery and the control circuit are electrically connected with the luminous component respectively.

13. The universal luminous flower pot base according to claim 4, characterized in that: the power supply is a solar energy supply component, which comprises a solar panel, a control circuit and a storage battery electrically connected with each other, wherein the storage battery and the control circuit are electrically connected with the luminous component respectively.

14. The universal luminous flower pot base according to claim 5, characterized in that: the power supply is a solar energy supply component, which comprises a solar panel, a control circuit and a storage battery electrically connected with each other, wherein the storage battery and the control circuit are electrically connected with the luminous component respectively.

15. The universal luminous flower pot base according to claim 6, characterized in that: the power supply is a solar energy supply component, which comprises a solar panel, a control circuit and a storage battery electrically connected with each other, wherein the storage battery and the control circuit are electrically connected with the luminous component respectively.

16. The universal luminous flower pot base according to claim 7, characterized in that: the power supply is a solar energy supply component, which comprises a solar panel, a control circuit and a storage battery electrically connected with each other, wherein the storage battery and the control circuit are electrically connected with the luminous component respectively.

17. The universal luminous flower pot base according to claim 8, characterized in that: the power supply is a solar energy supply component, which comprises a solar panel, a control circuit and a storage battery electrically connected with each other, wherein the storage battery and the control circuit are electrically connected with the luminous component respectively.

18. The universal luminous flower pot base according to claim 9, characterized in that: the power supply is a solar energy supply component, which comprises a solar panel, a control circuit and a storage battery electrically connected with each other, wherein the storage battery and the control circuit are electrically connected with the luminous component respectively.

19. The universal luminous flower pot base according to claim 9, characterized in that: the luminous component projects from a top surface of the protruding portion.
